(19) United States
(12) Patent Application Publication
(10) Pub. No.: US 2021/0232917 A1
(43) Pub. Date: Jul. 29, 2021

(54) ESTIMATING USEFUL LIFE

(71) Applicant: NEC Laboratories America, Inc., Princeton, NJ (US)

(72) Inventors: Masanao Natsumeda, Princeton Junction, NJ (US); Haifeng Chen, West Windsor, NJ (US)

(21) Appl. No.: 17/157,270

(22) Filed: Jan. 25, 2021

Related U.S. Application Data
(60) Provisional application No. 62/967,704, filed on Jan. 30, 2020.
(60) Provisional application No. 62/966,666, filed on Jan. 28, 2020.

(51) Int. Cl. G06N 3/08; G06Q 10/00; G06N 3/04

(52) U.S. Cl. CPC G06N 3/08; G06Q 10/0631; G06N 3/0454; G06Q 10/20

(57) ABSTRACT

A computer-implemented method is provided for hardware management based on estimating a Remaining Useful Life (RUL) of an object. The method includes estimating the RUL at a time point preceding the RUL by two RUL estimation methods respectively applied to a first time series subsequence and a second time series subsequence from among an overall time series sequence. The first time series subsequence includes run-to-event data used in a first one of the two RUL estimation methods. The second time series subsequence is applied to a leaky truncated RUL function as a second one of the two RUL estimation methods to obtain a model for RUL estimation. The method further includes estimating the RULE at inference using the first one of the two RUL estimation methods. The method also includes selectively servicing or replacing the object with a replacement object responsive to the RUL.

### RELATED APPLICATION INFORMATION

This application claims priority to U.S. Provisional Patent Application No. 62/967,704, filed on Jan. 30, 2020, and U.S. Provisional Patent Application No. 62/966,666, filed on Jan. 28, 2020, and incorporated herein by reference in their entireties.

### BACKGROUND

### Technical Field

The present invention relates to data evaluation and more particularly to estimating useful life.

### Description of the Related Art

Remaining Useful Life (RUL) estimation is a key element in predictive maintenance. Engineers schedule and carry out maintenance or other actions to keep the system's performance or specification.

Data driven approaches which utilize sensor and operational time series have gained popularity due to their ease of implementation. Due to the nature of measurement or degradation, accurate estimation is not always feasible. Existing methods suppose the range of RUL with feasible estimation is given from results at upstream tasks or domain knowledge. Such approaches suffer from either countless trial and errors resulting in significant cost to reach optimal solution or inaccurate estimation of remaining useful lifetime in case of inaccurate estimation of the feasible estimation range.

### SUMMARY

According to aspects of the present invention, a computer-implemented method is provided for hardware management based on estimating a Remaining Useful Life (RUL) of an object. The method includes estimating the RUL at a time point preceding the RUL by two RUL estimation methods respectively applied to a first time series subsequence and a second time series subsequence from among an overall time series sequence. The first time series subsequence includes run-to-event data used in a first one of the two RUL estimation methods. The second time series subsequence is applied to a leaky truncated RUL function as a second one of the two RUL estimation methods to obtain a model for RUL estimation. The method further includes estimating the RUL at inference using the first one of the two RUL estimation methods. The method also includes selectively servicing or replacing the object with a replacement object responsive to the RUL.

According to other aspects of the present invention, a computer program product is provided for hardware management based on estimating a Remaining Useful Life (RUL) of an object. The computer program product includes a non-transitory computer readable storage medium having program instructions embodied therewith. The program instructions are executable by a computer to cause the computer to perform a method. The method includes estimating the RUL at a time point preceding the RUL by two RUL estimation methods respectively applied to a first time series subsequence and a second time series subsequence from among an overall time series sequence. The first time series subsequence includes run-to-event data used in a first one of the two RUL estimation methods. The second time series subsequence is applied to a leaky truncated RUL function as a second one of the two RUL estimation methods to obtain a model for RUL estimation. The method further includes estimating the RUL at inference using the first one of the two RUL estimation methods. The method also includes selectively servicing or replacing the object with a replacement object responsive to the RUL.

According to yet other aspects of the present invention, a computer processing system is provided for hardware management based on estimating a Remaining Useful Life (RUL) of an object. The system includes a memory device for storing program code. The system further includes a processor device operatively coupled to the memory device for running the program code to estimate the RUL at a time point preceding the RUL by two RUL estimation methods respectively applied to a first time series subsequence and a second time series subsequence from among an overall time series sequence. The first time series subsequence includes run-to-event data used in a first one of the two RUL estimation methods. The second time series subsequence is applied to a leaky truncated RUL function as a second one of the two RUL estimation methods to obtain a model for RUL estimation. The processor device also runs the program code to estimate the RUL at inference using the first one of the two RUL estimation methods. The processor device further runs the program code to selectively service or replace the object with a replacement object responsive to the RUL.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device 10, in accordance with an embodiment of the present invention;

FIG. 2 is a block diagram showing a practical training scenario, in accordance with an embodiment of the present invention;

FIG. 3 is a block diagram showing a practical inference scenario, in accordance with an embodiment of the present invention;

FIG. 4 is a block diagram showing a Dual-estimator, in accordance with an embodiment of the present invention;

FIG. 5 is a block diagram showing a RUL estimation system, in accordance with an embodiment of the present invention;

FIG. 6 is a flow diagram showing an exemplary method for training an estimation model, in accordance with an embodiment of the present invention; and

FIG. 7 is a flow diagram showing an exemplary method for RUL estimation, in accordance with an embodiment of the present invention.

### DETAILED DESCRIPTION OF PREFERRED EMBODIMENTS

Embodiments of the present invention are directed to estimating useful life.

The present invention can be used for Remaining Useful Life (RUL) estimation and helps engineers to carry out predictive maintenance when needed.

There are many systems to which the present invention is applicable. Cyber physical systems including chemical plants, aircraft and railway system are but some of a myriad of examples of systems to which the present invention can be applied. In general, those systems in the real world equip sensors in order to monitor their status and their readings are saved as multivariate time series in a database. In addition, there is an operation to record historical events including failures and maintenance. If the event is a failure or maintenance, the description in historical records can include its name, solution and fault components.

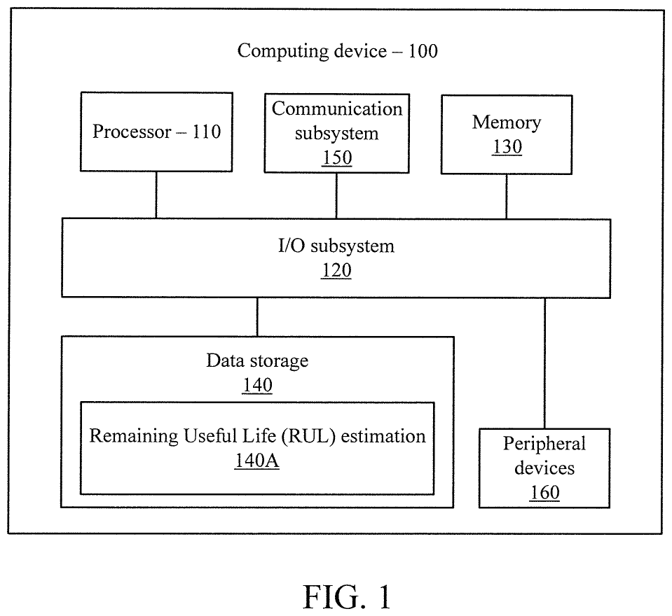

FIG. 1 is a block diagram showing an exemplary computing device 100, in accordance with an embodiment of the present invention. The computing device 100 is configured to perform Remaining Useful Life (RUL) estimation.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for Remaining Useful Life (RUL) estimation. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. Further, in another embodiment, a cloud configuration can be used. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

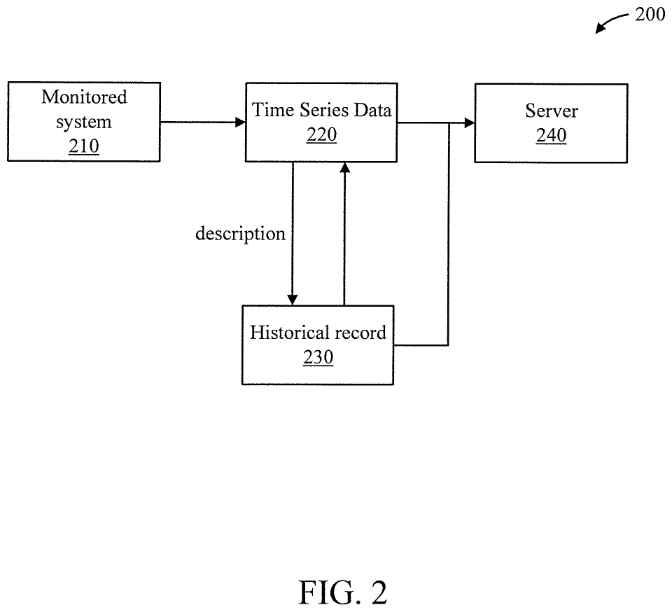

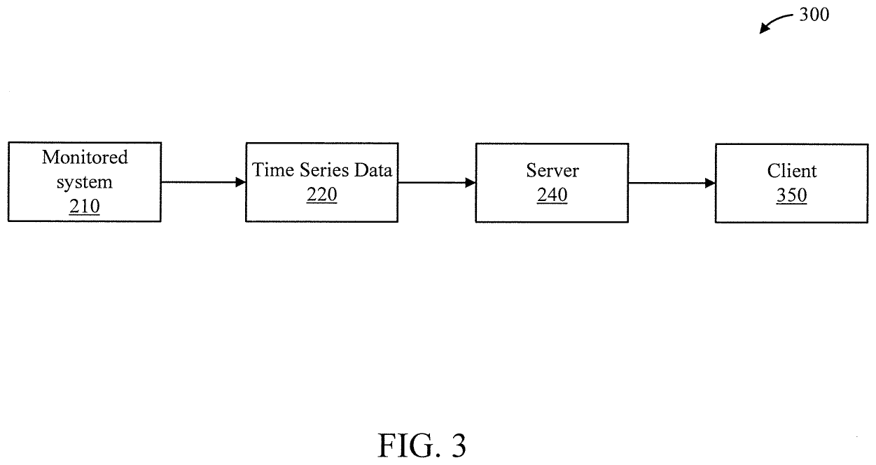

FIG. 2 is a block diagram showing a practical training scenario 200, in accordance with an embodiment of the present invention. FIG. 3 is a block diagram showing a practical inference scenario 300, in accordance with an embodiment of the present invention. However, it is to be appreciated that application of the present invention is not limited to these scenarios and, thus, may be applied to a myriad of other scenarios as readily appreciated by one of ordinary skill in the art.

The practical training scenario 200 involves a monitored system 210, time series data 220, a historical record 230, and a server 240. In an embodiment, the time series data 220 is obtained from the monitored system 210 and the same as well as descriptions (labels) thereof can be stored in the historical record 230 as well as provided to the server 240 for RUL estimation model building and training.

The practical inference scenario 300 involves the monitored system 210, the time series data 220, the server 240, and a client 350. The server 240 can estimate RUL, e.g., periodically, randomly, or continuously. If the RUL is shorter than a threshold, then the server 240 alerts the client 350 and provides a pre-defined solution to the client 350.

At first, a RUL estimation model is built with given multivariate time series data 220 and its historical record 230 as shown in FIG. 2. Once the model is trained, the model in a storage unit of the server 240 periodically estimates RUL using the given segment of time series data as shown in FIG. 3 and provides the estimated rule to client 350. If RUL is shorter than the pre-determined threshold, the server 240 notifies that to the users through the client 350.

The following frame end-to-end learning for RUL estimation is proposed, which is interchangeably referred to herein as “RULENet”.

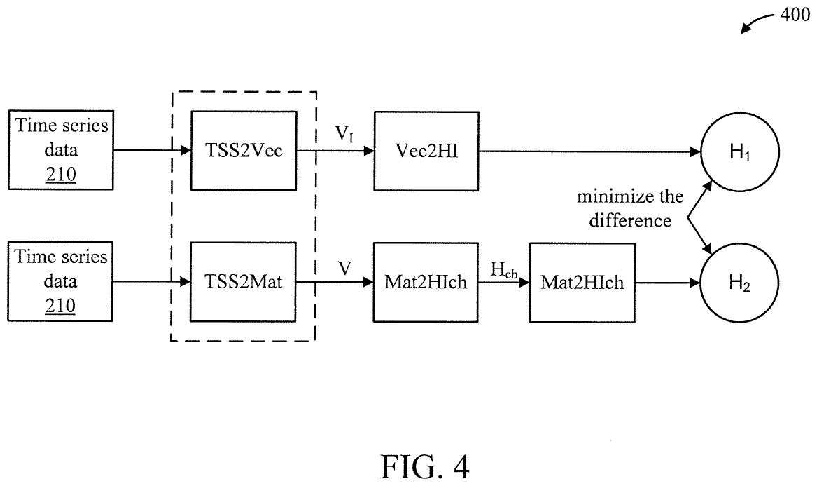

The present invention simultaneously optimizes its Dual-estimator for RUL estimation and feasible range estimation. As shown in the block diagram of FIG. 4, a Dual-estimator 400 in accordance with an embodiment of the present invention includes the following five components: Tss2vec; Tss2Mat; Vec2HI; Mat2HIch; and HIch2HI. The Dual-estimator uses all components at training and uses Tss2vec and Vec2HI at inference.

Let X^{(k)} be the k example from K run-to-failure data X, where X^{(k,j)} represents j^{th} observation at the example and X^{(k,lk)} is the observation at the failure. Here j denotes the time index in run-to-failure data whose smaller value indicates older records, lₖ denotes the length of the time series and the time index at the failure. X^{(k,lk)} is a vector with length A, here A denotes the number of attributes, e.g., sensors or operational setting. It is to be appreciated that a subsequence of X^{(k)} can be x. Moreover, it is to be appreciated that the present invention is not limited to run-to-failure data. For example, the present invention can be used with run-to-event data, which is time series data collected during a period from a usual status to a certain status, for example in the latter case, a status which requires maintenance.

Let x^{(k,j)} be a subsequence of X^{(k)} starting at 1^{st} time index and ending at j^{th} time index, v^{(k,j)} be its feature representation, and V^{(k)}=[v^{(k,l)}, v^{(k,2)}, . . . , v^{(k,lk)}] be the feature representation for the entire X^{(k)}. Note that the beginning of x^{(k,j)} can be at the beginning of X^{(k)} but that is not necessary (not a requirement). Given x^{(k,j)}, Tss2vec outputs its feature representation v^{(k,j)}, and Vec2HI gives RUL estimation at j as Hᵢ^{(k,j)}, based upon v^{(k,j)}. Given a kth example of run-to-failure data X^{(k)}, Tss2Mat outputs V^{(k)} and then Mat2HIch converts V^{(k)} to the change point of HI H_{ch}^{(k)}. Finally, HIch2HI gives RUL estimation at j as H₂^{(k,j)} based upon H_{ch}^{(k)}.

Tss2vec and Tss2Mat are identical except for their input and output. Tss2vec takes a subsequence x^{(k,j)} and gives a vector v^{(k,j)}. Tss2Mat just iterates the process for all j and concatenates all the vectors to be a matrix. The intuition behind this design is better feature representation works not only for RUL estimation but also for the feasible range estimation. The design also helps to reduce the search space of parameters.

At training, the Dual-estimator 400 takes an example of run-to-failure data X^{(k)} and its subsequence x^{(k,j)} as the inputs at a time, and then it gives two RUL estimations, H₁^{(k,j)} and H₂^{(k,j)}.

At inference, it takes a multivariate time series for RUL estimation x as the input, then it outputs H, which is HI at the end of the time series data x.

In an embodiment, Tss2vec and Tss2Mat can be stacked LSTMs. In an embodiment, Vec2HI can be a Multi-layer Perceptron.

In principal, Mat2HIch can be any function mapping a matrix to a single value, but it might be inappropriate for RUL estimation since the number of examples for training is limited due to its nature. Restricting search space is a promising candidate. In an embodiment, it is proposed to use a weighted average of true RUL, where the weights are determined by a neural network (e.g., an attention mechanism), based upon v^{(k,j)} and must sum to one, independent of the length of sequence. It enforces the solution bounds to the maximum true RUL in the training examples to zero and to be represented by the weighted average.

Let R^{(k,j)} be the true RUL at a j^{th} time index in a k^{th} run-to-failure and a^{(k,j)} be the weight, then

$${H}_{c h}^{k} = {\sum }_{j = 0}^{{l}_{k}} {a}^{( k , j )} {R}^{( k , j )} .$$

A gated attention mechanism is employed to capture complex relationships among feature representations. In an embodiment, the gated attention mechanism gives the weights as follows:

$${a}^{( k , j )} = \frac{exp \{ w ( tanh ( P {v}^{( k , j )} ) ⊙ sigm ( Q {v}^{( k , j )} ) ) \}}{{Σ}_{i = 0}^{{l}_{k}} exp \{ w ( tanh ( P {v}^{( k , i )} ) ⊙ sigm ( Q {v}^{( k , i )} ) ) \}}$$

where w, P and Q are parameters optimized through training, ⊙ is element-wise multiplication, sigm( ) is sigmoid function. The w is a vector. The P and Q are matrices. Their dimensions are determined to give a scalar value as a^{(k,j)}.

The simplest HIch2HI is the piece-wise RUL function. However, it might have potential problems since the gradient is zero for the region from H_{ch} to larger. In order to deal with the potential problem, it is proposed to give a negative slope for the region. The function leaky truncated RUL function is referred to as H(R, H_{ch}), which takes a value of true RUL R and a value of change point of health index H_{ch} that yields:

[symbol]

(R,H_{ch})=min(y₁(R,H_{ch}),y₂(R,H_{ch})),

where:

y₁(R,H_{ch})=−a₁(−R+H_{ch})+H_{ch},

y₂(R,H_{ch})=−a₂(−R+H_{ch})+H_{ch},

where a₁ and a₂ are scalar parameters, and a₂<<a₁.

The Dual-estimator 400 gives two estimations of RUL at the time index j as follows: H₁^{(k,j)} and H₂^{(k,j)}. Although they are from different methods, they must be similar to each other. In an embodiment, that is why minimization of the difference between H₁^{(k,j)} and H₂^{(k,j)} is a goal and the loss L_{b} is given by:

$${L}_{b} = {\sum }_{〈 j , k 〉} {( {H}_{1}^{( k , j )} - {H}_{2}^{( k , j )} )}^{2}$$

where <j, k> represents a pair of the indices in the training data. H₁^{(k,j)} is arbitrary but H₂^{(k,j)} is not. H₂^{(k,j)} is constraint by a leaky truncated RUL function, which means there is only one parameter to change its value over a kth example of run-to-failure data. In addition, H₂^{(k,j)} must be more accurate since Mat2HIch and HIch2HI can observe an entire run-to-failure data and it includes future information from the perspective of the pipeline with TSS2Vec and Vec2HI. Due to these mechanisms, H₂^{(k,j)} plays as a teacher for TSS2Vec and Vec2HI. Eventually, the pipeline with TSS2Vec and Vec2HI gives accurate RUL estimation without future information. However, it is inappropriate just to minimize the difference due to the trivial solution, which is H_{ch}^{(k)}=0. When H_{ch}^{(k)}=0, H₁^{(k,j)} and H₂^{(k,j)} become zero and it is easily achievable just ignoring values in the input data X^{(k)}. In order to avoid a trivial solution, a term of auxiliary loss, called value loss, is added which is given by:

$${L}_{v} = {\sum }_{〈 j , k 〉} {( \frac{1}{{H}_{c h}^{( k )}} )}^{2} .$$

Note that H_{ch}^{(k)} is given for every j as well since a pair of X^{(k)} and its subsequence x^{(k,j)} is the input and a training sample. This auxiliary loss enforces having larger values of H_{ch}^{(k)}, and affects the representation learning at Tss2Vec due to weight sharing. This means the better feature representation should give not only a better RUL estimation but also a better change point of HI. Finally, the loss function L is given by:

L=L_{b}+λLᵥ,

where λ is a hyper-parameter.

Available data for training is divided into training data and validation data. The model is trained with the Mini-batch gradient descent and its parameters are optimized with every training sample for a number of iterations. During an iteration, a performance metric is computed for the validation data. If the performance metric is better than that from the previous iteration, the parameters are kept as the best parameter at the moment. In order to determine the best hyper-parameter, a cross-validation method is employed.

The performance metric should be designed for each use case based upon its requirements. In typical cases, there is a range of interest for RUL estimation since no action is needed at a sufficient RUL (e.g., above a threshold) and no action can be taken at a quite short RUL (e.g., below another threshold).

Let hₑₛₜ⁽ⁱ⁾ be an estimated RUL, and hₜᵣᵤₑ⁽ⁱ⁾ be the true RUL. Given the range as rmin to rmax and estimation error d⁽ⁱ⁾, then the performance metric P is given as:

$$P = {\sum }_{i ∈ D} P ( {d}^{( i )} ) ,$$

where:

d⁽ⁱ⁾=hₑₛₜ⁽ⁱ⁾−hₜᵣᵤₑ⁽ⁱ⁾

D={i∈ [symbol] |rₘᵢₙ≤rᵢ≤rₘₐₓ},

and P(.) is a function to compute a performance metric for an estimation. In an embodiment, it can be Root Mean Square Error and acceptable prediction. Note that the training metric is not limited to this notation. It can be any metrics in prognostics as readily appreciated by one of ordinary skill in the art. There could be various variants, as readily appreciated by one of ordinary skill in the art.

By the present invention, a feature representation is generated for all time points in training data. It means some feature representation is not generated with sufficient information. Especially at the beginning of a sequence, it does not include any temporal information. It may harm models. In order to guarantee a minimum amount of information, in an embodiment, a minimum sequence length is introduced in order to generate a feature representation.

A brief summary will be given of some of the features of the present invention.

In an embodiment time series data from the past to current time can be used to generate a feature vector. However, this setting may not work or not be efficient for training when irrelevant but significant change exists in the middle of the subsequence. In order to eliminate undesirable effects from the past, a sliding window can be employed in a manner to extract subsequences for Tss2Vec and Tss2Mat. In order to reduce computational burden, a sliding window can be applied to extract subsequences for either Tss2Vec or Tss2Mat or both.

In an embodiment, a stacked LSTM is used for Tss2Vec and Tss2Mat, and MLP is used for Vec2HI. They have relatively simple structures. Tss2Vec and Tss2Mat can be any artificial neural networks which can convert a matrix to a vector and a matrix. Vec2HI can be any artificial neural networks which convert a vector to a scalar value. In other embodiments, more complex models such as, for example, the Transformer, can be used to capture more complex information in data.

In an embodiment, preprocessing techniques can be used especially for treatment of operating conditions so that the explicit mapping from operational settings to operating conditions is not necessary. The Dual-estimator may take feature values which represent operation settings.

In an embodiment, the loss L_{b} can be given by a function which more penalizes larger difference between H₁^{(k,j)} and H₂^{(k,j)}. Meanwhile, the loss Lᵥ can be given by a function which more penalizes smaller H_{ch}^{(k)}. For example, it can be:

$${L}_{v} = {\sum }_{〈 j , k 〉} \{ {( \frac{1}{{H}_{c h}^{( k )}} )}^{2} - {( \frac{1}{{R}_{max}} )}^{2} \} .$$

where Rₘₐₓ is a maximum true RUL at training.

In an embodiment, an RUL estimation system can be designed that restricts setting a threshold value for RUL estimation smaller than a maximum of the health indices at the change point during training.

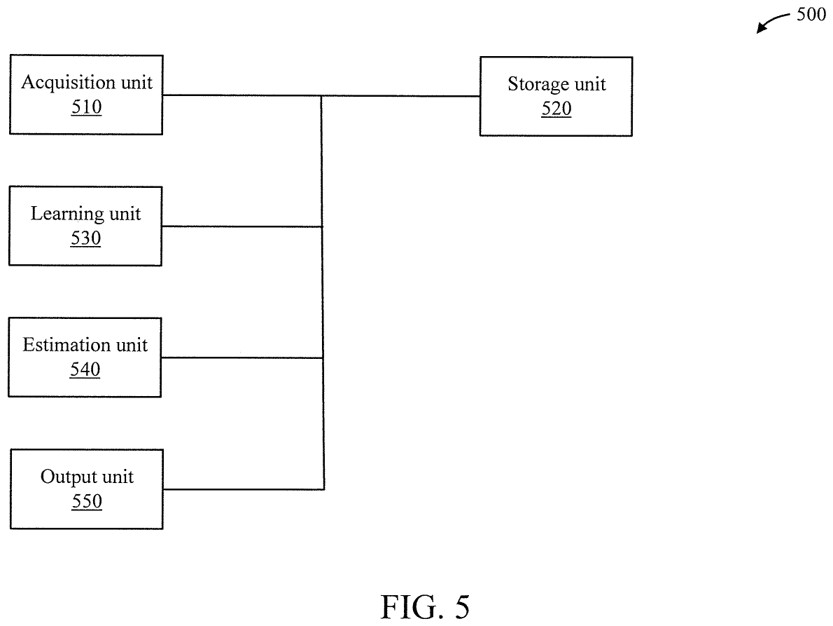

FIG. 5 is a block diagram showing a RUL estimation system 500, in accordance with an embodiment of the present invention. Acquisition unit 510 obtains run-to-failure time series for training the model and, time series data for estimating RUL. In an embodiment, the data can be from outside of RUL Estimation system 500. In another embodiment, it can be from storage unit 520. Storage unit 520 stores the models. Learning unit 530 trains the models. Estimation unit 540 estimates RUL as described herein. Output unit 550 controls the output to users.

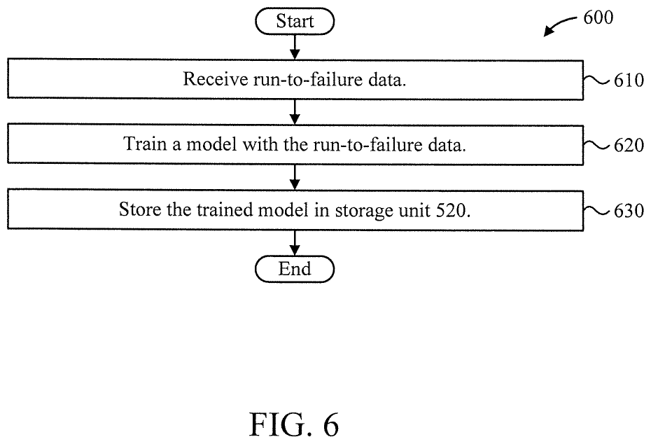

FIG. 6 is a flow diagram showing an exemplary method 600 for training an estimation model, in accordance with an embodiment of the present invention.

At block 610, acquisition unit 510 receives run-to-failure data.

At block 620, learning unit 530 trains a model with the run-to-failure data.

At block 630, learning unit 530 stores the trained model in storage unit 520.

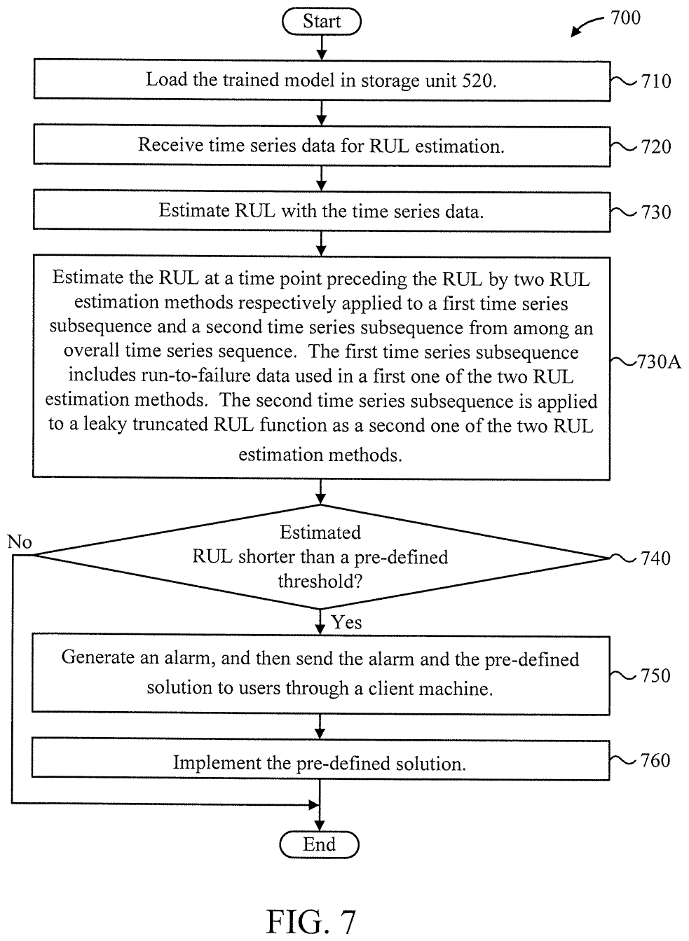

FIG. 7 is a flow diagram showing an exemplary method 700 for RUL estimation, in accordance with an embodiment of the present invention.

At block 710, estimation unit 540 loads the trained model in storage unit 520.

At block 720, acquisition unit 510 receives time series data for RUL estimation.

At block 730, estimation unit 540 estimates RUL with the time series data.

In an embodiment, block 730 can include block 730A.

At block 730A, estimate the RUL at a time point preceding the RUL by two RUL estimation methods respectively applied to a first time series subsequence and a second time series subsequence from among an overall time series sequence. The first time series subsequence includes run-to-failure data used in a first one of the two RUL estimation methods. The second time series subsequence is applied to a leaky truncated RUL function as a second one of the two RUL estimation methods.

At block 740, it is judged whether the estimated RUL is shorter than a pre-defined threshold.

At block, 750, output unit 550 generates an alarm, and then sends the alarm and the pre-defined solution to users through a client machine. The client device can be a smart phone, a laptop, a desktop, a server, and so forth. Otherwise, output unit 550 does nothing (the method is terminated).

At block 760, the client device implements the pre-defined solution. The pre-defined solution can include, for example, but it is not limited to selectively servicing a device or replacing part, up to all, of a device deemed to have exceeded the threshold and hence its RUL as per the generation of the alarm in block 750. In an embodiment, block 760 can be performed at a time before the estimated RUL in order to avoid machine down time for, e.g., the replacement of a processor based machine (a cutting machine, a centrifuge, a microscope, a computer processing chip with additional circuitry, and so forth). In an embodiment, the pre-defined solution can involve bypassing a machine (using, e.g., a hardware switch) to enable to use of a replacement machine (e.g., a processor-controlled battery, etc.). Maintenance can involving changing a servicing a motor and so forth.

According to an aspect of the present invention, a computer-implemented method is provided for hardware replacement based on estimating a Remaining Useful Life (RUL) of an object. The method includes estimating the RUL at a time point preceding the RUL by two RUL estimation methods respectively applied to a first time series subsequence and a second time series subsequence from among an overall time series sequence. The first time series subsequence includes run-to-failure data used in a first one of the two RUL estimation methods. The second time series subsequence is applied to a leaky truncated RUL function as a second one of the two RUL estimation methods. The method further includes replacing the object with a replacement object responsive to the RUL.

According to another aspect of the present invention, the second time series subsequence includes the run-to-failure data used in the first one of the two RUL estimation methods.

According to yet another aspect of the present invention, the first one of the two RUL estimation methods estimates a change point as a weighted summation of true RULs of the second time series.

According to still another aspect of the present invention, weights for the weighted summation are determined by a neural network.

According to a further aspect of the present invention, the method further includes training a model, used for the estimating step, using a loss function. The loss function includes a first term to minimize a difference between two consecutive estimated RULs including the RUL. The loss function further includes a second term to maximize the RUL at a change point constrained by a RUL error metric.

According to another aspect of the present invention, the estimating step includes converting the first time series subsequence into a vector for RUL computation, and converting the second time series subsequence into vectors for another RUL computation through change point estimation.

According to yet another aspect of the present invention, the converting steps are performed with identical trained models.

According to still another aspect of the present invention, the method further includes computing a performance metric while training a model used for the estimating step. A set of parameters of the trained model having a highest value for the performance metric is used for an inference stage that includes the estimating step.

According to a further aspect of the present invention, the performance metric is designed to have a value, that increases with an increasing RUL at a change point, together with a RUL estimation error within a pre-defined acceptable range.

According to a yet further aspect of the present invention, the method further includes outputting the RUL responsive to the RUL being smaller than a change point, and indicating the RUL as healthy responsive to the RUL being equal to or larger than the change point.

According to yet another aspect of the present invention, the method further includes training a model used for the estimating step. The training is constrained such that a threshold value larger than a maximum value of the RUL at a change point is blocked from being set.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for hardware management based on estimating a Remaining Useful Life (RUL) of an object, the method comprising:
estimating the RUL at a time point preceding the RUL by two RUL estimation methods respectively applied to a first time series subsequence and a second time series subsequence from among an overall time series sequence, the first time series subsequence comprising run-to-event data used in a first one of the two RUL estimation methods, the second time series subsequence being applied to a leaky truncated RUL function as a second one of the two RUL estimation methods to obtain a model for RUL estimation;
estimating the RUL at inference using the first one of the two RUL estimation methods; and
selectively servicing or replacing the object with a replacement object responsive to the RUL.

2. The computer-implemented method of claim 1, wherein the second time series subsequence comprises the run-to-event data used in the first one of the two RUL estimation methods.

3. The computer-implemented method of claim 1, wherein the second one of the two RUL estimation methods estimates a change point as a weighted summation of true RULs of the second time series.

4. The computer-implemented method of claim 1, wherein weights for the weighted summation are determined by a neural network.

5. The computer-implemented method of claim 1, further comprising training a model, used for said estimating step, using a loss function, wherein the loss function comprises a first term to minimize a difference between two estimated RULs including the RUL for their identical true RUL, and wherein the loss function further comprises a second term to maximize the RUL at a change point constrained by a RUL error metric.

6. The computer-implemented method of claim 1, wherein said estimating step comprises:
converting the first time series subsequence into a vector for RUL computation; and
converting the second time series subsequence into vectors for another RUL computation through change point estimation.

7. The computer-implemented method of claim 6, wherein said converting steps are performed with identical trained models.

8. The computer-implemented method of claim 1, further comprising computing a performance metric while training a model used for said estimating step, wherein a set of parameters of the trained model having a highest value for the performance metric is used for an inference stage that comprises said estimating step.

9. The computer-implemented method of claim 8, wherein the performance metric is designed to have a value, that increases with an increasing RUL at a change point, together with a RUL estimation error within a pre-defined acceptable range.

10. The computer-implemented method of claim 1, further comprising:
outputting the RUL responsive to the RUL being smaller than a change point; and
indicating the RUL as healthy responsive to the RUL being equal to or larger than the change point.

11. The computer-implemented method of claim 1, further comprising training a model used for said estimating step, wherein the training is constrained such that a threshold value larger than a maximum value of the RUL at a change point is blocked from being set.

12. A computer program product for hardware management based on estimating a Remaining Useful Life (RUL) of an object, the computer program product comprising a non-transitory computer readable storage medium having program instructions embodied therewith, the program instructions executable by a computer to cause the computer to perform a method comprising:
estimating the RUL at a time point preceding the RUL by two RUL estimation methods respectively applied to a first time series subsequence and a second time series subsequence from among an overall time series sequence, the first time series subsequence comprising run-to-event data used in a first one of the two RUL estimation methods, the second time series subsequence being applied to a leaky truncated RUL function as a second one of the two RUL estimation methods to obtain a model for RUL estimation;
estimating the RUL at inference using the first one of the two RUL estimation methods; and
selectively servicing or replacing the object with a replacement object responsive to the RUL.

13. The computer program product of claim 12, wherein the second time series subsequence comprises the run-to-event data used in the first one of the two RUL estimation methods.

14. The computer program product of claim 12, wherein the second one of the two RUL estimation methods estimates a change point as a weighted summation of true RULs of the second time series.

15. The computer program product of claim 12, wherein weights for the weighted summation are determined by a neural network.

16. The computer program product of claim 12, wherein the method further comprises training a model, used for said estimating step, using a loss function, wherein the loss function comprises a first term to minimize a difference between two estimated RULs including the RUL for their identical true RUL, and wherein the loss function further comprises a second term to maximize the RUL at a change point constrained by a RUL error metric.

17. The computer program product of claim 12, wherein said estimating step comprises:
converting the first time series subsequence into a vector for RUL computation; and
converting the second time series subsequence into vectors for another RUL computation through change point estimation.

18. The computer program product of claim 17, wherein said converting steps are performed with identical trained models.

19. The computer program product of claim 12, wherein the method further comprises computing a performance metric while training a model used for said estimating step, wherein a set of parameters of the trained model having a highest value for the performance metric is used for an inference stage that comprises said estimating step.

20. A computer processing system for hardware management based on estimating a Remaining Useful Life (RUL) of an object, the system comprising:
a memory device for storing program code; and
a processor operatively coupled to the memory device for running the program code to:
estimate the RUL at a time point preceding the RUL by two RUL estimation methods respectively applied to a first time series subsequence and a second time series subsequence from among an overall time series sequence, the first time series subsequence comprising run-to-event data used in a first one of the two RUL estimation methods, the second time series subsequence being applied to a leaky truncated RUL function as a second one of the two RUL estimation methods to obtain a model for RUL estimation;
estimate the RUL at inference using the first one of the two RUL estimation methods; and
selectively service or replace the object with a replacement object responsive to the RUL.
